(19) United States
(12) Patent Application Publication
(10) Pub. No.: US 2018/0356553 A1
(43) Pub. Date: Dec. 13, 2018

(54) SIGNAL CANCELLATION IN PIPE INSPECTION

(71) Applicant: Halliburton Energy Services, Inc., Houston, TX (US)

(72) Inventors: Luis Emilio San Martin, Houston, TX (US); Reza Khalaj Amineh, Houston, TX (US); Burkay Donderici, Pittsford, NY (US)

(21) Appl. No.: 16/061,077

(22) PCT Filed: Feb. 24, 2016
(86) PCT No.: PCT/US2016/019321

§ 371 Date: Jun. 11, 2018

(51) Int. Cl. G01V 3/38; G01V 3/28; E21B 47/08; E21B 47/12; G01V 3/30; G01V 3/34

(52) U.S. Cl. CPC G01V 3/38; G01V 3/28; G01V 3/34; E21B 47/124; G01V 3/30; E21B 47/082

(57) ABSTRACT

Disclosed are methods, systems, and tools for pipe inspection that employ signals from electromagnetic waves emitted towards and scattered in the pipe(s). Various embodiments relate to tool configurations and associated methods for tool operation and signal processing that allow for the reduction or substantial cancellation of the direct signal contribution resulting from direct transmission of the emitted electromagnetic wave from a transmitter to a receiver of the tool.

### BACKGROUND

In oil and gas field operations, it is often useful to monitor the condition of the production pipe and intermediate casing pipe in a completed borehole, as corrosion of these components can hinder oil production by leaks and cross-flows, thereby rendering well operation inefficient. Since pipe removal is both expensive and time-consuming, particularly in offshore platforms, it is desirable to analyze the pipe condition in situ. A common technique to do so involves emitting electromagnetic waves, e.g., to induce Eddy currents in the pipes, and measuring the resulting electromagnetic response signals at various positions along the pipes. Proper analysis of the response signals facilitates determining geometric and/or material parameters of the pipes (e.g., pipe thickness, pipe diameter, degree of concentricity of multiple nested pipes, electrical conductivity, magnetic permeability), and can, for instance, reveal pipe metal losses with high accuracy.

### BRIEF DESCRIPTION OF THE DRAWINGS

FIG. 1 is a diagram of a pipe inspection system deployed in an example borehole environment, in accordance with various embodiments.

FIG. 2 is a diagram of an example pipe inspection tool in accordance with various embodiments.

FIG. 3 is a diagram of magnetic fields surrounding the pipe inspection tool of FIG. 2 in accordance with various embodiments.

FIG. 4 is a diagram of the pipe inspection tool of FIG. 2, illustrating different voltages measured in accordance with various embodiments.

FIG. 5 is a diagram of a pipe inspection tool including more than two main/bucking receiver pairs, in accordance with various embodiments.

FIG. 6 is a flow chart of a pipe inspection method in accordance with various embodiments.

FIG. 7 is a block diagram illustrating numerical-inversion techniques for processing electromagnetic response signals in accordance with various embodiments.

### DESCRIPTION

This disclosure relates, in various embodiments, to pipe inspection tools including one or more electromagnetic transmitters and one or more electromagnetic receivers. When a pipe inspection tool is deployed in a pipe, or in a set of multiple nested pipes, the response signal measured at each receiver typically includes a direct signal contribution resulting from direct transmission of the emitted electromagnetic wave to the receiver as well as an indirect signal contribution resulting from scattering of the electromagnetic waves in the pipe(s)—usually, only the latter is of interest, as it carries information about the geometric and/or material parameters of the pipes. Accordingly, it is desirable to cancel or at least reduce the direct signal contribution from the acquired response signal. The present disclosure provides tool configurations and associated methods for tool operation and signal processing that facilitate such direct-signal cancellation or reduction.

Of course, the complete elimination of the direct signal contribution is, in general, practically not achievable, as will be readily appreciated. Accordingly, the terms “cancel” and “cancellation” are herein used synonymously with “substantially cancel” and “substantial cancellation,” and generally refer to a reduction of the direct signal contribution to a level significantly below the indirect signal contribution (e.g., a level that is less than a fifth, or even less than a hundredth, of the indirect-signal level). Furthermore, for a given tool configuration, cancellation of the direct signal in one environment (e.g., air) does not necessarily entail direct signal cancellation to the same degree in every environment, but may allow for a larger remaining direct signal contribution in a different environment (e.g., inside a set of pipes), as signals are generally affected by the environment in which they are measured. Accordingly, direct signal cancellation is herein defined with respect to a controlled environment in which the tool may be calibrated, and means that the direct signal measured in such controlled environment (e.g., in air, or in a selected pipe configuration) is reduced to substantially zero.

In various embodiments, the electromagnetic receivers are or include antenna coils, and the voltage induced across a coil constitutes the measured response signal. Direct-signal cancellation is achieved by pairing a “main” receiver with a “bucking” receiver that is configured, e.g., by virtue of its distance from the transmitter, number of windings in the antenna coil, length of the coil, or diameter of the winding, to measure a direct signal contribution that is substantially the same as that acquired by the main receiver, but generally a different indirect signal contribution than that acquired by the main receiver. Then, subtraction of the “bucking” signal acquired by the bucking receiver from the signal acquired by the main receiver achieves cancellation of the direct signal contribution in the resulting differential signal. As explained in detail below, such subtraction can be accomplished in hardware or software in different ways, and the terms “subtract” and “subtraction,” as used in this context, are to be broadly understood as encompassing all manners of obtaining the differential signal.

In various embodiments, the receivers are placed about the longitudinal axis of the pipe inspection tool (i.e., the axis that is parallel to the borehole axis when the tool is in use) on opposite sides of and/or at different distances from the transmitter. Beneficially, this linear arrangement allows keeping the tool diameter small (e.g., at or below two inches) so as to accommodate the diameter constraints imposed in many existing well geometries. Thus, compared with tools that employ multiple collocated receiver coils of different diameters in a multi-level configuration, the linear, single-level arrangement affords a wider range of applicability.

Among two receivers configured as a pair whose direct signal contributions cancel, the designation of one of the receivers as the main receiver and of the other one as the bucking receiver is arbitrary and serves merely convenience of reference. Either one of the receivers can be considered as “bucking” the direct signal contribution of the other one; in various embodiments, the receiver that is closer to the pipe section to be inspected with a given measurement is functionally considered to be the bucking receiver. Further, a single receiver can belong to multiple pairs of receivers. For example, in a linear arrangement of first, second, and third receivers located at increasing distances from the transmitter, the signal acquired by the first receiver may be used to buck the second receiver's signal, which may, in turn, buck the signal measured at the third receiver. Consistent with this example, in embodiments with receivers at different distances from the transmitter, the receiver farther from the transmitter may be viewed as the main receiver.

In some embodiments, the main and bucking receivers are, or include, receiver coils that differ in both their respective distances from the transmitter and in their respective numbers of windings, and are configured such that a higher number of windings at the more distant coil compensates for the lower strength of the directly received electromagnetic wave, resulting in substantially equal direct signal contributions in both coils. (The terms “substantially equal,” “substantially the same,” and similar phrases used herein to indicate that some deviation from perfect equality is permissible are meant to imply that the direct signal contributions of main and bucking coils are sufficiently close to result, upon subtraction, in substantial cancellation as defined above.) By contrast, the indirect signal contributions generally do not cancel because the combined set of main and bucking receivers is sensitive to the scattered signal from the pipes surrounding the tool; these scattered signals are generally proportional to the thickness of the surrounding pipes.

In alternative embodiments, the main and bucking coils have the same numbers of windings and the same sizes (e.g., the same lengths and diameters) and are located at substantially the same distance from the transmitter at opposite sides thereof (e.g., in a linear arrangement). This, again, results in substantially equal direct-signal contributions. In the event of perfect symmetry (about a plane through the transmitter and perpendicular to the pipe and borehole axes) in the pipes themselves (e.g., absent any changes in thickness and material properties along the pipe), the indirect signal contributions cancel as well in this configuration. However, any defects in the pipes cause a non-zero indirect signal contribution that is generally proportional to the difference (e.g., in thickness) between the pipe portions above and below the transmitter.

Since electromagnetic signals are complex in nature, they have two dimensions: e.g., amplitude and phase, or real and imaginary parts. Suitable configurations of the main and bucking receivers (e.g., in terms of their windings and distances from the transmitter as described above) generally facilitate cancellation or minimization of the direct signal contribution in (a selected) one of these dimensions, but not necessarily in both. Accordingly, unless indicated to the contrary, direct-signal cancellation herein refers to the cancellation of the direct signal contributions in at least one dimension. In certain embodiments that utilize a pair of coils with equal numbers of windings located on opposite sides of the transmitter at equal distances therefrom, direct-signal cancellation in both dimensions can be achieved.

Alternatively to using a single transmitter in conjunction with multiple receivers, a pipe inspection tool may also use multiple transmitters in conjunction with only one receiver. In such embodiments, the roles of transmitters and receivers are essentially reversed, with pairs of transmitters located on opposite sides of and/or at different distances from the receiver being configured to cause substantially equal direct signal contributions at the receiver, resulting in substantial cancellation of the direct signal contributions in a combined response signal measured across the receiver. (As will be readily appreciated, when multiple response signals due to electromagnetic waves emitted by multiple transmitters are measured simultaneously across a single receiver, they are inherently combined, with their respective polarities, obviating the need for a separate step of forming a differential response signal.) For the sake of clarity, only embodiments that utilize multiple receivers and one transmitter will be illustrated and described in the following. A person of ordinary skill in the art given the benefit of the present disclosure will, however, know how to implement these and other embodiments of the principles discussed herein with reversed roles for transmitters and receivers, and embodiments that include main and bucking transmitters and only one receiver are, accordingly, to be considered within the scope of the disclosed subject matter. Furthermore, the scope of the instant disclosure is intended to extend to pipe inspection tools with multiple receivers and multiple transmitters, where direct-signal cancellation is accomplished both by subtracting signals measured with multiple receivers based on waves transmitted by a single one of the transmitters, and by measuring a composite signal at a single receiver that results from waves simultaneously emitted by multiple transmitters.

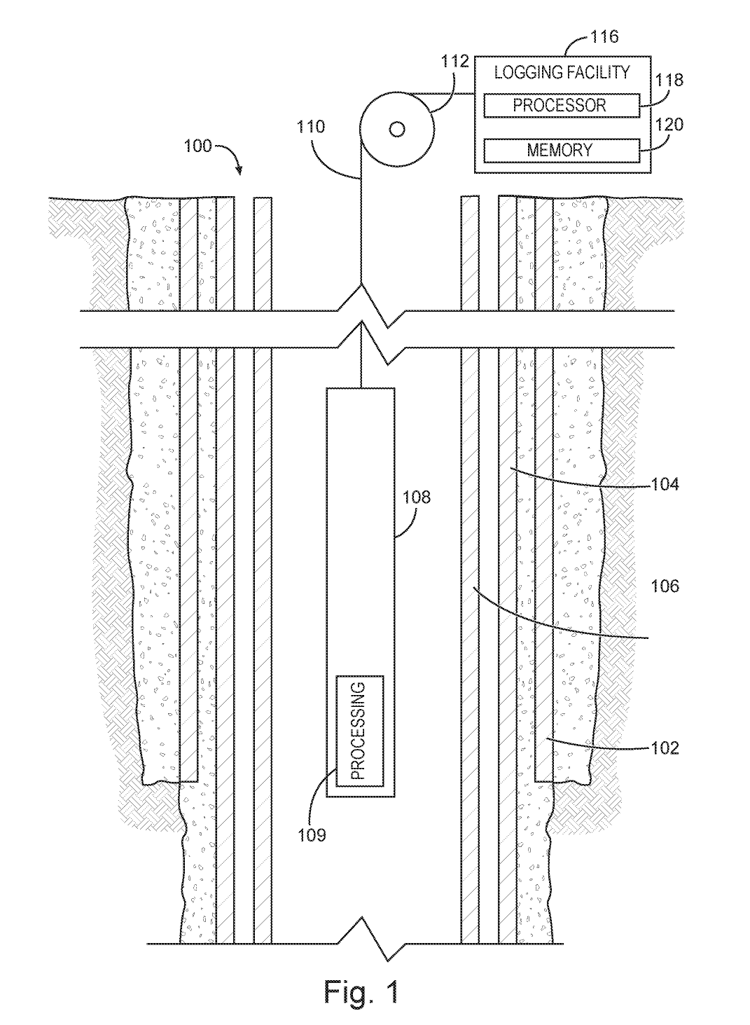

Referring now to the accompanying drawings, FIG. 1 is a diagram of a pipe inspection system deployed in an example borehole environment, in accordance with various embodiments. The borehole 100 is shown during a wireline logging operation, which is carried out after drilling has been completed and the drill string has been pulled out. As depicted, the borehole 100 has been completed with surface casing 102 and intermediate casing 104, both cemented in place, Further, a production pipe 106 has been installed in the borehole 100. The production pipe 106 may have a small diameter, e.g., less than two inches, imposing a corresponding outer-diameter constraint on any tools deployed therein. While three pipes 102, 104, 106 are shown in this example, the number of nested pipes may generally vary, depending, e.g., on the depth of the borehole 100.

Wireline logging generally involves measuring physical parameters of the borehole 100 and surrounding formation—such as, in the instant case, the condition of the pipes 102, 104, 106—as a function of depth within the borehole 100. The pipe measurements may be made by lowering a pipe inspection tool 108 into the wellbore 100, for instance, on a wireline 110 wound around a winch 112 mounted on a logging truck. The wireline 110 is an electrical cable that, in addition to delivering the tool 108 downhole, may serve to provide power to the tool 108 and transmit control signals and/or data between the tool 108 and a logging facility 116 (implemented, e.g., with a suitably programmed general-purpose computer including one or more processors 118 and memory 120) located above surface, e.g., inside the logging truck. In some embodiments, the tool 108 is lowered to the bottom of the region of interest and subsequently pulled upward, e.g., at substantially constant speed. During this upward trip, the tool 108 may perform measurements on the pipes, either at discrete positions at which the tool 108 halts, or continuously as the pipes pass by. In accordance with various embodiments, the measurements involve emitting electromagnetic waves towards the pipes and measuring a response signal that generally includes scattered electromagnetic waves. The response signal may be communicated to the logging facility 116 for processing and/or storage thereat. Alternatively, the response signal may be processed at least partially with suitable analog or digital circuitry 109 contained within the tool 108 itself (e.g., an embedded microcontroller executing suitable software). Either way, a log, that is, a sequence of measurements correlated with the depths along the wellbore 100 at which they are taken, is generated. The computer or other circuitry used to process the measured electromagnetic signals to derive pipe parameters based thereon is hereinafter referred to as the processing facility, regardless whether it is integrated into the tool 108 as circuitry 109, provided in a separate device (e.g., logging facility 116), or both in part. Collectively, the pipe inspection tool 108 and processing facility (e.g., 109 and/or 116) are herein referred to as a pipe inspection system.

Alternatively to being conveyed downhole on a wireline, as described above, the pipe inspection tool 108 can be deployed using other types of conveyance, as will be readily appreciated by those of ordinary skill in the art. For example, the tool 108 may be lowered into the borehole by slickline (a solid mechanical wire that generally does not enable power and signal transmission), and may include a battery or other independent power supply as well as memory to store the measurements until the tool 108 has been brought back up to the surface and the data retrieved. Alternative means of conveyance include, for example, coiled tubing, downhole tractor, or drill pipe (e.g., used as part of a tool string within or near a bottom-hole-assembly during logging/measurement-while-drilling operations).

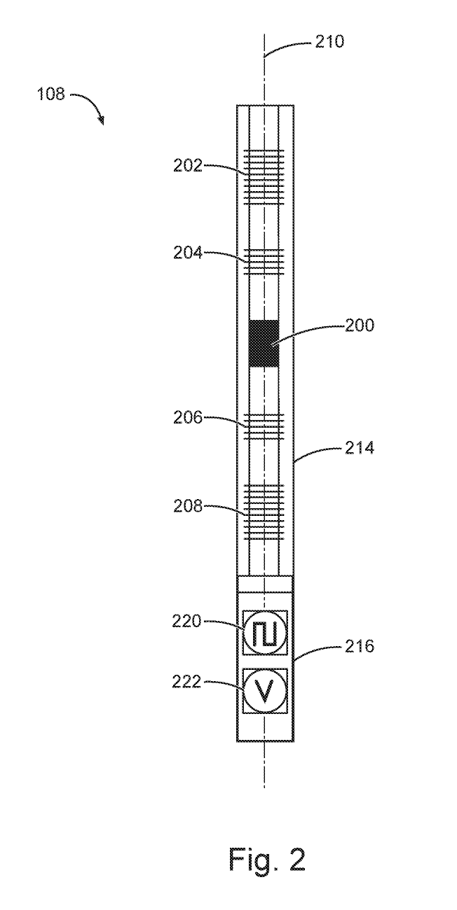

FIG. 2 is a diagram of an example pipe inspection tool 108 in accordance with various embodiments. In the depicted example, the tool 108 includes an electromagnetic transmitter 200 and four electromagnetic receivers 202, 204, 206, 208 positioned along the longitudinal tool axis 210 in a linear configuration. The receivers 202, 204, 206, 208 are arranged symmetrically about the transmitter 200 (two receivers 202, 204 being located above and two receivers 206, 208 being located below the transmitter 200). In various embodiments, the transmitter 200 and receivers 202, 204, 206, 208 each include an antenna coil wound around the longitudinal axis 210, but other antenna types and configurations may also be used. In some embodiments, one or more of the antenna coils 200, 202, 204, 206, 208 include a large number of coil windings, e.g., one thousand windings or more; coils with many windings are particularly suitable for pipe inspection measurements because of the low frequency of operation and resulting low signal level or sensitivity associated with a single winding. The transmitter 200 and receivers 202, 204, 206, 208 may be housed in a protective non-magnetic metal sleeve 214 (e.g., made of aluminum, titanium or a similar non-magnetic material), Metal is suitable for the sleeve due to its mechanical strength. The pipe inspection tool 108 further includes an electronics board 216, which may be located at one end of the tool 108, below (as depicted) or above the transmitter/receiver arrangement, and may be enclosed in the sleeve 214. (While it is in principle possible to place the electronics board 216 in a different location, e.g., underneath the sleeve 214, surrounding the coils 200, 202, 204, 206, 208, tool configurations that minimize the diameter of the tool 108 by placing the electronics board at a different position along the tool axis 210 than the coils 200, 202, 204, 206, 208 are often desirable.) The electronics board 216 includes circuitry configured to drive the transmitter 200 with an alternating voltage or current to cause the emission of electromagnetic waves. For example, the driver circuitry may be or include a digital waveform generator 220, electrically connected to the transmitter 200, that generates a voltage in a frequency range suitable and/or optimized for pipe measurements, e.g., a frequency range below 20 Hz to allow penetration into second and other pipes, and above 0.1 Hz to allow a sufficient signal level at the receiver and meet the data acquisition speed requirements. The electronics board 216 further includes circuitry for measuring and/or processing the electromagnetic response signal, e.g., voltage measurement circuitry 222 for measuring the voltages across individual receiver coils 202, 204, 206, or 208, and/or differential voltages between two (or more) of the receivers 202, 204, 206, 208, and optionally circuitry 109 for processing the differential voltages (not shown). Voltage measurements may be performed by high-impedance devices to enable very accurate measurements and avoid signal distortions resulting from the measurements. Furthermore, the electronics board 216 may include telemetry circuitry (not shown) for transmitting data up-hole to a logging facility 116.

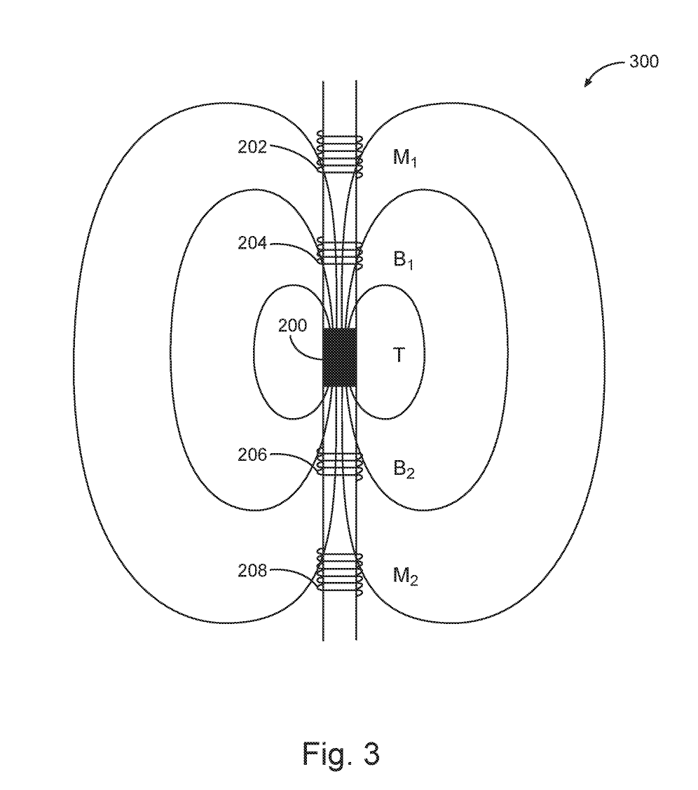

FIG. 3 is a diagram of magnetic fields 300 surrounding the pipe inspection tool 108 of FIG. 2 in free space. At the receiver locations, these fields result in the direct signal contribution. As illustrated by the magnetic field line density, which decreases with increasing distance from the transmitter 200, the fields measured at the various receivers are weaker for receivers more distant from the transmitter 200. When using two receiver coils at different distances from the transmitter 200 as a pair of main and bucking coils for direct-signal-cancellation purposes, the farther coil (e.g., coil 202) may be configured with more windings than the closer coil (e.g., coil 204) to compensate for this difference in field strengths, exploiting the fact that the voltage across a coil (which serves as the response signal) is proportional to the number of windings. Thus, by appropriately configuring the number of windings and the positions of two coils within the tool 108 to obtain substantially equal signal magnitudes of the two response signals measured with the respective coils, and then combining the two response signals into a differential signal, direct-signal cancellation can be achieved. Since the direct signal in free space has only an imaginary part and zero real part, cancellation of direct signal is equivalent to cancellation of the imaginary part of the signal. However, when the coils are placed in pipes and wrapped around a conductive or magnetically permeable core, an arbitrary complex-valued direct signal with both real and imaginary parts may be defined. In such case, cancellation may be performed to cancel out the imaginary part (which is the standard mode of operation) or the real part of the signal. Alternatively, instead of cancelling out real or imaginary parts, the magnitude of the signal may be minimized. (Completely cancelling the magnitude is generally not possible.) The approach which yields the largest desired signal (due to thickness change) to direct signal may be chosen. In various embodiments, the number of windings and positions are determined for direct-signal cancellation in air, either experimentally by calibration, or based on theoretical considerations by simulation or calculation. The combined set of main and bucking coils is sensitive to scattered waves coming from the pipes that surround the tool 108. These scattered waves, which cause the indirect signal contributions, are in general proportional to the thickness of the surrounding pipes.

Direct-signal cancellation can also be achieved with main and bucking coils located on opposite sides of transmitter 200. This allows, as a special case of selecting appropriate distances and numbers of windings, using two coils with the same number of windings placed at equal distances from the transmitter (e.g., receiver coils 202 and 208). In this symmetric tool configuration, the differential signal measured between the two coils 202, 208 is zero absent any asymmetry in the pipes to be inspected. Thus, any non-zero differential signal measures a difference between the pipe portions above and below the transmitter 200. Beneficially, the symmetric configuration allows cancelling the direct signal contributions in both magnitude and phase (i.e., in two dimensions).

The differential signal can be obtained in various ways. In some embodiments, the voltages induced at the main and bucking coils are subtracted from each other directly in hardware by serially connecting the negative poles of the coils and measuring the signal voltage between the positive poles or vice versa, In one embodiment, a bucking coil (e.g., coil 204) placed between the main coil (e.g., coil 202) and the transmitter is wound in the opposite direction as the main coil, such that the voltages induced at the two coils have opposite polarity in a given direction along the tool axis. Connecting the two coils at the ends located between the coils (i.e., connecting the upper end of the lower coil to the lower end of the upper coil), e.g., by using the same wire for both coils, then allows directly measuring the differential voltage between the ends that bracket both coils (i.e., the upper end of the upper coil and the lower end of the lower coil). The same effect can be achieved, alternatively, by winding both coils in the same direction and directly connecting their two upper ends or their two lower ends so as to connect poles of the same type. Similarly, in embodiments that use main and bucking coils on opposite sides of the transmitter, the coils may be wound in opposite directions and connected to each other at the ends between the coils, allowing the differential voltage to be measured between the ends bracketing both coils, or the coils may be wound in the same direction and connected to each other at their two upper ends or their two lower ends.

In some embodiments, the differential voltage is formed by subtracting two voltages measured individually over the main and bucking coils. This can be accomplished by dedicated, special-purpose circuitry (which may be programmable), or using software executed by a general-purpose processor. While fixed hardware-based subtraction between the main and bucking signals may be more accurate in various embodiments, a software-based implementation may be beneficial if greater flexibility in designating and pairing bucking and receiver coils is desired.

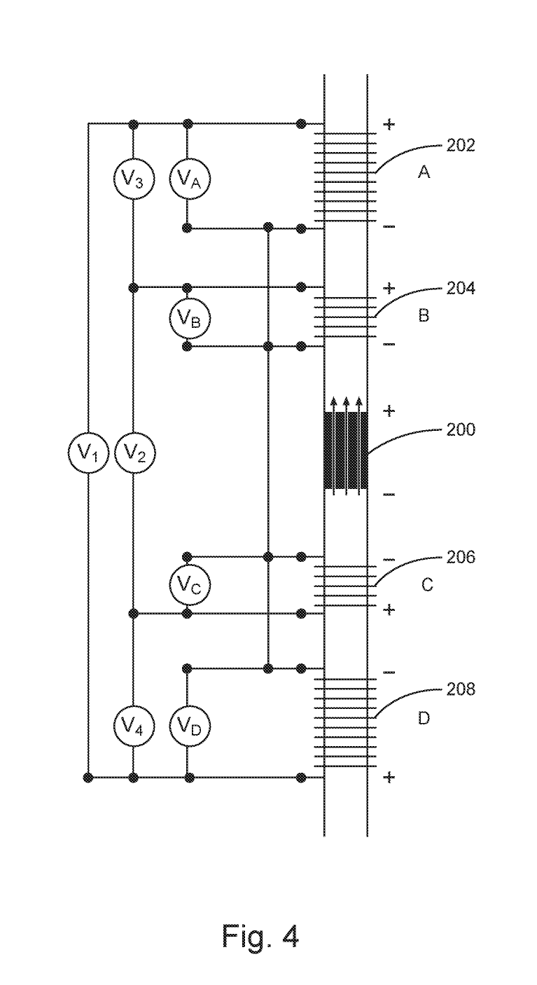

FIG. 4 is a diagram of the pipe inspection tool of FIG. 2, illustrating different voltages measured in accordance with various embodiments. In the depicted configuration, the receiver coils 202, 204 above the transmitter 200 are both wound in one direction (resulting in parallel polarities of the two coils), and the receiver coils 206, 208 below the transmitter 200 are both wound in the other direction resulting in polarities that are parallel to each other and antiparallel to those of the receiver coils 202, 204 above the transmitter 200). The two pairs of coils 202, 204 and 206, 208 are assumed to have been bucked in air. The individual voltages measured across the receiver coils 202, 204, 206, 208 are labeled V_{A}, V_{B}, V_{C}, and V_{D}, respectively. Differential voltage V₁=V_{A}−V_{D} is measured between the symmetrically positioned receiver coils 202, 208, and differential voltage V₂=V_{B}−V_{C} is measured between the symmetrically positioned receiver coils 204, 206. Differential voltage V₃=V_{A}−V_{B} is measured between the two receiver coils 202, 204 above the transmitter 200, and differential voltage V₄=V_{C}−V_{D} is measured between the two receiver coils 206, 208 below the transmitter 200. The differential voltages may also be used in various combinations. For example, a voltage V_{combined}=V₃−V₄=V_{A}−V_{B}−V_{C}+V_{D} can be calculated to combine bucking on either side of the transmitter 200 with a differential measurement between the two sides.

Different ones of the differential voltages may be advantageous under different circumstances. For example, in the inspection of non-magnetic or low-magnetic pipes, the differential voltages V₃ and V₄ measured on either side of the transmitter may be beneficial in that they provide a response signal resulting from scattering inside the pipes, while the effect of the direct signal has been minimized by bucking in air. In the inspection of magnetic pipes, on the other hand, the differential voltages V₃ and V₄ may be less useful because the presence of the magnetic pipes affects the bucking condition strongly, possibly resulting in substantial direct signal contributions. This issue can be avoided by using the differential voltages V₁ and V₂ measured between coils on opposite sides of the transmitter, which, for nominal pipe sections (that is, in the absence of defects), provide a zero response regardless of the magnetic properties of the pipes. In the presence of a defect that is not axially symmetric about the location of the transmitter, the voltages V₁ and V₂ are solely due to the defect. In case assumption of axially asymmetric defect is not satisfied, the differential voltages V₁ and V₂ will be close to zero, resembling the response for non-defective pipes. In this instance, differential voltages measured with main and bucking receivers on the same side of the transmitter (e.g., differential voltages V₃ and/or V₄) may be advantageous because they allow backing out the absolute thickness of the pipes rather than thickness differentials (since, due to the lack of symmetry in the fields, the indirect signal contributions differ between the coils even for nominal pipe sections). Accordingly, to allow for a broad range of applicability, it is beneficial to combine, in a single pipe inspection tool, main/bucking coil pairs on the same side of the transmitter with main/bucking coil pairs on opposite sides of the transmitter, optionally in addition to using coils with various sizes, numbers of windings, spacings, etc., to achieve sensitivity of the differential voltages to individual pipes as well as a desired resolution.

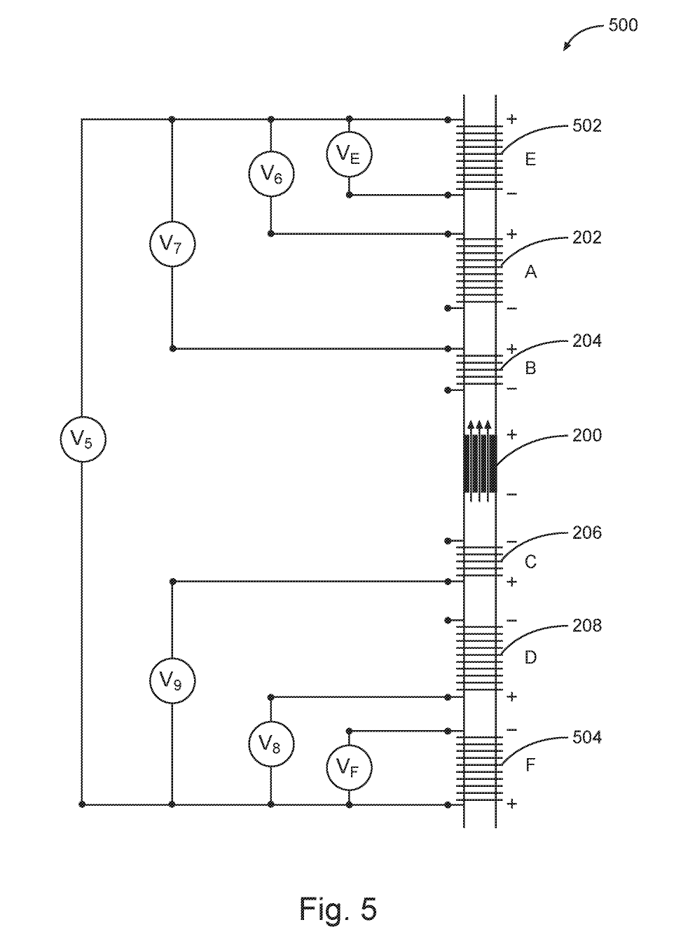

Of course, the pipe inspection tool need not be limited to two pairs of main/bucking receivers. FIG. 5 is a diagram of a pipe inspection tool 500 that includes, for instance, three main/bucking receiver pairs. Compared with the tool 200 of FIGS. 2-4, the tool 500 includes a third coil 502 above the transmitter and a third coil 504 below the transmitter; as shown, the additional coils 502, 504 may be arranged symmetrically about the transmitter 200. Accordingly, the tool 500 provides for two additional individual voltages V_{E} and V_{F}, an additional differential voltage V₅=V_{E}−V_{F} between the two symmetric coils 502, 504, and, on each side of the transmitter 200, two additional bucked voltages V6=VE−VA, V7=VE−VB and V8=VF−VC, V9=VF−VD, respectively. It will be readily appreciated that a pipe-inspection tool with direct-signal-cancellation capability can generally have any number of two or more receiver coils arranged in various ways on either or both sides of the transmitter.

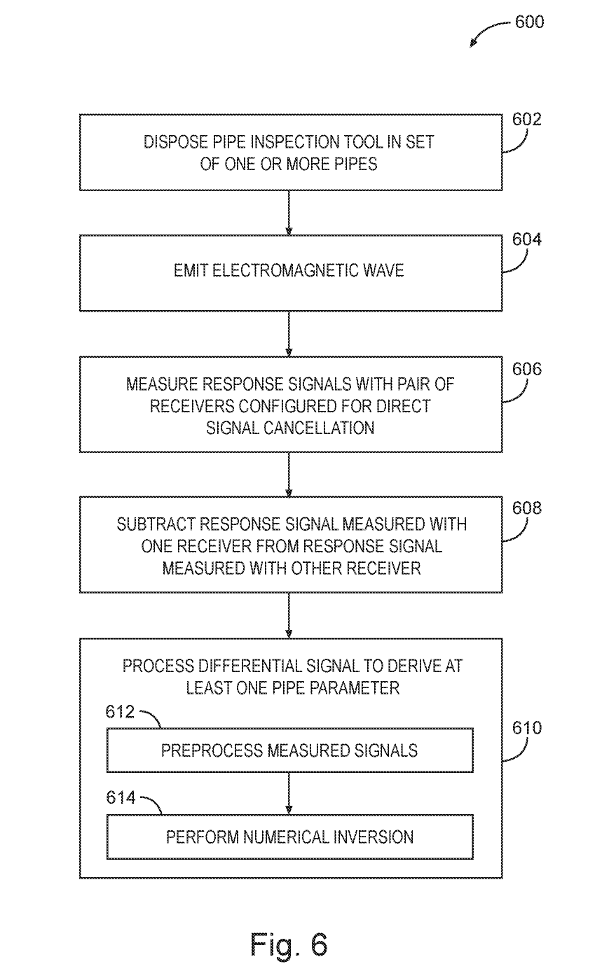

FIG. 6 is a flow chart of a pipe inspection method in accordance with various embodiments. The method 600 involves disposing a pipe inspection tool including a pair of receivers configured for direction signal cancellation (e.g., based on calibration in air) in a set of one or more pipes (act 602). Further, the method 600 involves emitting an electromagnetic wave with a transmitter of the tool (act 604), measuring response signals (e.g., in the form of voltages) with the two receivers of the pair of receivers (act 606), and subtracting the response signal received with one of the receivers from the response signal received with the other one of the receivers (act 608). As described above, the subtraction can be implicit in measuring a differential signal directly between the two receivers, or involve an extra step for digitally processing two individually measured response signals. Either way, a differential signal with substantially vanishing direct signal contribution is obtained. This differential signal can then be processed to derive at least one pipe parameter (e.g., a pipe thickness, pipe diameter, magnetic permeability, or electrical conductivity) associated with the set of one or more pipes (act 610). In various embodiments, the pipe inspection tool includes multiple pairs of receivers configured for direct signal cancellation (e.g., as illustrated in FIGS. 4 and 5), and the method includes measuring and processing multiple differential response signals.

The signal processing (act 610) may involve pre-processing the acquired raw response signals (act 612), e.g., by filtering or averaging across multiple response signals to reduce noise, taking the difference or ratio between multiple response signals to remove unwanted effects such as a common voltage drift due to temperature, implementing other temperature correction schemes (e.g., using a temperature correction table), calibrating the response signals to known or expected parameter values from an existing well log, performing array-processing of measured signals from multiple receivers at different locations to adjust the depth of detection and/or the vertical and/or azimuthal resolution (also known as “focusing”), and/or by other pre-processing operations known in the field of electromagnetic well logging. The pre-processed signals can then be inverted (act 614) for the desired pipe parameters. The signal processing can be implemented with program code executed by a general-purpose processor or with a special-purpose processor, e.g., in a processing facility integrated into the pipe inspection tool 108 and/or the surface logging facility 116.

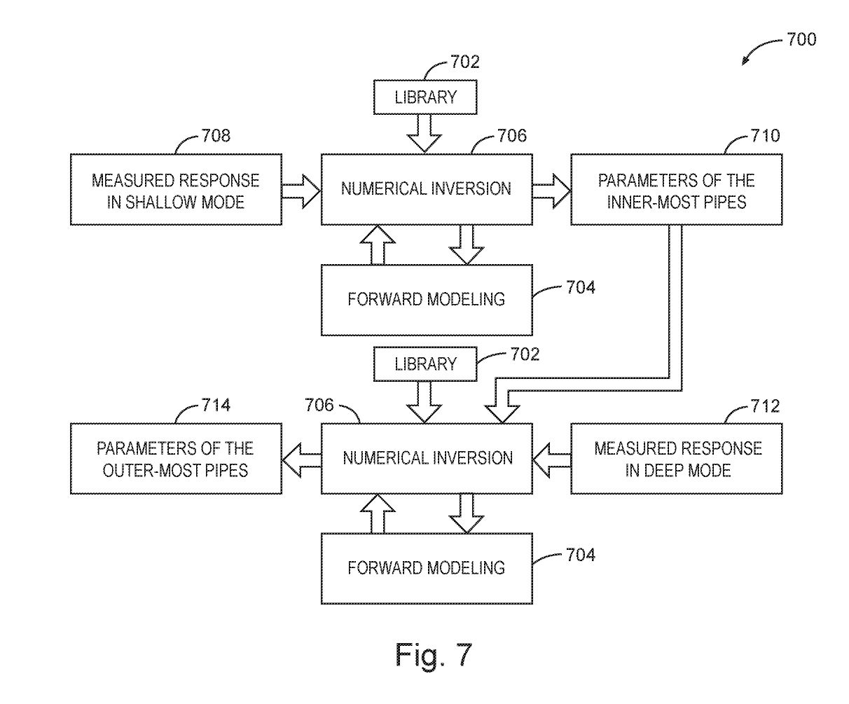

FIG. 7 is a block diagram illustrating numerical-inversion techniques 700 for processing electromagnetic response signals in accordance with various embodiments. In general, the measured (differential) response signal is compared to signals stored in a library 702 or signals computed with a forward-modeling code 704, both of which are based on a numerical model of the set of pipes, and parameters of the set of pipes are then iteratively numerically optimized (at 706) to minimize a difference between the measured response signal and the signal obtained from the library 702 or the forward model 704, In various embodiments, the measured response signal 708 acquired in a “shallow mode” (that is, using higher frequencies, or coils that are smaller or have fewer turns) is first used to estimate the inner-most pipes parameters 710. Thereafter, the measured response signal 712 acquired in a “deep mode” (that is, using lower frequencies or coils that are larger or have more turns) is used to estimate the parameters 714 of the outer pipes. Effects due to the presence of the tool housing and mutual coupling between receivers can be corrected for based on a-priori information on parameters characterizing these effects, or by solving for some or all of these parameters during the inversion process. Removal of such effects is well-known in the field of electromagnetic well logging.

Beneficially, direct signal cancellation in accordance herewith, and inversion of the resulting differential response signals, may allow for detecting and estimating the size of smaller defects than are discernable without such direct signal cancellation, and can thus enable more valid predictions for the useful life-time of the pipes and more appropriate decisions for replacing any flawed pipe sections.

The following numbered examples are illustrative embodiments,

1. A method comprising: using a pipe inspection tool disposed in a set of one or more pipes, emitting an electromagnetic wave with a transmitter of the tool and acquiring electromagnetic response signals with a plurality of respective receivers of the tool, the response signals comprising direct signal contributions due to direct transmission of the emitted electromagnetic wave to the respective receivers, the plurality of receivers comprising first and second receivers configured such that the direct signal contributions in their response signals are substantially equal at least in a first dimension; subtracting a first response signal received with the first receiver from a second response signal received with the second receiver to obtain a differential signal in which the signal contributions substantially cancel at least in the first dimension; and processing the differential signal to derive based thereon at least one pipe parameter associated with the set of one or more pipes, the at least one pipe parameter comprising at least one of a pipe thickness, a pipe diameter, a magnetic permeability, or an electrical conductivity.

2. The method of example 1, wherein the first signal is subtracted from the second signal by directly measuring the differential signal between the first and second receivers,

3. The method of example 1, wherein the first and second signals are separately measured and the first signal is subsequently subtracted from the second signal to obtain the differential signal.

4. The method of any preceding example, wherein the first and second receivers are located on the same side of the transmitter.

5. The method of example 4, wherein the plurality of receivers further comprises a third receiver located on the same side of the transmitter as the first and second receivers and receiving a third response signal, the second and third receivers being configured such that the direct signal contributions in their response signals are substantially equal in the first dimension or in a second dimension different from the first dimensions, the method further comprising subtracting the second response signal from the third response signal to obtain a second differential signal in which the signal contributions substantially cancel in the dimension in which they are substantially equal.

6. The method of any of examples 1-3, wherein the first and second receivers are located on opposite sides of the transmitter.

7. The method of example 6, wherein the first and second receivers are coils having substantially equal numbers of windings and sizes, and being located at substantially equal distances from the transmitter, the direct signal contributions in the differential signal further cancelling in a second dimension different from the first dimension,

8. The method of example 6 or example 7, wherein the plurality of receivers comprises a third receiver receiving a third response signal, the third receiver being located on the same side of the transmitter as the first receiver and configured such that the direct signal contributions of the first response signal and the third response signal are substantially equal in one of the first and second dimensions, the method further comprising subtracting the first response signal from the third response signal to obtain a second differential signal in which the signal contributions substantially cancel in the one of the first or second dimensions.

9. The method of example 8, wherein the plurality of receivers further comprises a fourth receiver receiving a fourth response signal, the fourth receiver being located on the same side of the transmitter as the second receiver and at substantially the same distance from the transmitter as the third receiver, the third and fourth receivers being coils having substantially the same numbers of windings, the method further comprising subtracting the third response signal from the fourth response signal to obtain a third differential signal in which the direct signal contributions substantially cancel in the first and second dimensions and subtracting the second response signal from the fourth response signal to obtain a fourth differential signal in which the direct signal contributions substantially cancel in the one of the first or second dimensions.

10. The method of any of example 1-9, wherein the electromagnetic wave is emitted in a frequency range below 20 Hz.

11. A pipe inspection tool comprising: an electronics board comprising a digital-waveform generator configured to generate a voltage in a frequency range below 20 Hz; a transmitter coil configured to emit an electromagnetic wave in response to application of the generated voltage; a plurality of receiver coils configured to acquire electromagnetic response signals , the response signals comprising direct signal contributions due to direct transmission of the emitted electromagnetic wave to the respective receivers, the plurality of receivers comprising first and second receivers configured such that direct signal contributions in their response signals substantially cancel, in at least one dimension, in a differential signal formed by subtraction of the first response signal from the second response signal.

12. The pipe inspection tool of example 11, further comprising a non-magnetic metal sleeve enclosing the transmitter and the plurality of receivers.

13. The pipe inspection tool of example 11 or example 12, wherein the first and second receivers are coils having equal numbers of windings and equal sizes and are located on opposite sides of the transmitter at substantially equal distances from the transmitter.

14. The pipe inspection tool of example 13, wherein the plurality of receivers further comprises a third receiver located on the same side of the transmitter as the first receiver, the second and third receivers being configured such that the direct signal contributions in their response signals cancel, in at least one dimension, in a second differential signal formed by subtraction of the first response signal from the third response signal.

15. A system comprising: a pipe inspection tool to be disposed in a set of one or more pipes, the tool comprising a transmitter to emit an electromagnetic wave and a plurality of receivers to acquire resulting electromagnetic response signals comprising direct signal contributions due to direct transmission of the emitted electromagnetic wave to the respective receivers, the plurality of receivers comprising first and second receivers configured such that the direct signal contributions in their respective first and second response signals substantially cancel, in at least one dimension, in a differential signal formed by subtraction of the first response signal from the second response signal; and a signal-processing facility to process the differential signal to derive based thereon at least one pipe parameter associated with the set of one or more pipes, the at least one pipe parameter comprising at least one of a pipe thickness, a pipe diameter, a magnetic permeability, or an electrical conductivity.

16. The system of example 15, wherein the pipe inspection tool further comprises voltage measurement circuitry connected to the first and second receivers so as to directly measure the differential signal.

17. The system of example 15, wherein the pipe inspection tool is configured to separately measure the first and second response signals, the signal-processing facility being configured to subtract the first response signal from the second response signal.

18. The system of any of examples 15-17, wherein the first and second receivers are located on opposite sides of the transmitter at substantially equal distances from the transmitter and comprise receiver coils having substantially equal numbers of windings and equal sizes.

19. The system of example 18, wherein the plurality of receivers further comprises a third receiver located on the same side of the transmitter as the first receiver, the first and third receivers being configured such that the direct signal contributions in their response signals cancel, in at least one dimension, in a second differential signal formed by subtraction of the first response signal from a third response signal received with the third receiver.

20. The system of example 19, wherein the signal-processing facility is to derive the at least one pipe parameter associated with the set of one or more pipes based further on the second differential signal.

21. A method comprising: using a pipe inspection tool disposed in a set of one or more pipes, emitting electromagnetic waves with a plurality of transmitters of the tool and acquiring respective electromagnetic response signals with a receiver of the tool, the response signals comprising direct signal contributions due to direct transmission of the emitted electromagnetic waves from the respective transmitters to the receiver, the plurality of transmitters comprising first and second transmitters configured such that the direct signal contributions in the respective response signals are substantially equal and opposite at least in a first dimension; measuring a combined response signal across the receiver, the direct signal contributions in the response signals resulting from electromagnetic waves emitted by the first and second transmitters substantially cancelling in the combined response signal at least in the first dimension; and processing the combined response signal to derive based thereon at least one pipe parameter associated with the set of one or more pipes, the at least one pipe parameter comprising at least one of a pipe thickness, a pipe diameter, a magnetic permeability, or an electrical conductivity.

22. The method of example 21, wherein the first and second transmitters are located on the same side of the receiver.

23. The method of example 21, wherein the first and second transmitters are located on opposite sides of the receiver.

24. The method of example 23, wherein the first and second transmitters are coils having substantially equal numbers of windings and sizes, and being located at substantially equal distances from the receiver, the direct signal contributions in the combined response signal further cancelling in a second dimension different from the first dimension.

25. The method of any of examples 21-24, wherein the electromagnetic waves are emitted in a frequency range below 20 Hz.

26. A pipe inspection tool comprising: an electronics board comprising a digital-waveform generator configured to generate a voltage in a frequency range below 20 Hz; a plurality of transmitters configured to emit electromagnetic waves in response to application of the generated voltage; a receiver configured to acquire respective electromagnetic response signals, the response signals comprising direct signal contributions due to direct transmission of the electromagnetic waves emitted by the plurality of respective transmitters to the receiver, the plurality of transmitters comprising first and second transmitters configured such that direct signal contributions in their response signals substantially cancel, in at least one dimension, in a combined signal measured across the receiver.

27. The pipe inspection tool of example 26, further comprising a non-magnetic metal sleeve enclosing the plurality of transmitters and the receiver,

28. The pipe inspection tool of example 26 or example 27, wherein the first and second transmitters have equal numbers of windings and equal sizes and are located on opposite sides of the receiver at substantially equal distances from the receiver.

29. A system comprising: a pipe inspection tool to be disposed in a set of one or more pipes, the tool comprising a plurality of transmitters to emit electromagnetic waves and a receiver to acquire resulting electromagnetic response signals comprising direct signal contributions due to direct transmission of the emitted electromagnetic waves from the respective transmitters to the receiver, the plurality of transmitters comprising first and second transmitters configured such that the direct signal contributions in their respective first and second response signals substantially cancel, in at least one dimension, in a combined response signal measured across the receiver; and a signal-processing facility to process the combined response signal to derive based thereon at least one pipe parameter associated with the set of one or more pipes, the at least one pipe parameter comprising at least one of a pipe thickness, a pipe diameter, a magnetic permeability, or an electrical conductivity.

30. The system of example 29, wherein the pipe inspection tool further comprises voltage measurement circuitry for measuring the combined response signal.

31. The system of example 29 or example 30, wherein the first and second transmitters are located on opposite sides of the receiver at substantially equal distances from the receiver and comprise coils having substantially equal numbers of windings and equal dimensions.

Many variations may be made in the system, devices, and techniques described and illustrated herein without departing from the scope of the inventive subject matter. Accordingly, the described embodiments are not intended to limit the scope of the inventive subject matter. Rather, the scope of the inventive subject matter is to be determined by the scope of the following claims and all additional supported by the present disclosure, and all equivalents of such claims.

What is claimed is:

1. A method comprising:
using a pipe inspection tool disposed in a set of one or more pipes, emitting an electromagnetic wave with a transmitter of the tool and acquiring electromagnetic response signals with a plurality of respective receivers of the tool, the response signals comprising direct signal contributions due to direct transmission of the emitted electromagnetic wave to the respective receivers, the plurality of receivers comprising first and second receivers configured such that the direct signal contributions in their response signals are substantially equal at least in a first dimension;
subtracting a first response signal received with the first receiver from a second response signal received with the second receiver to obtain a differential signal in which the signal contributions substantially cancel at least in the first dimension; and
processing the differential signal to derive based thereon at least one pipe parameter associated with the set of one or more pipes, the at least one pipe parameter comprising at least one of a pipe thickness, a pipe diameter, a magnetic permeability, or an electrical conductivity.

2. The method of claim 1, wherein the first signal is subtracted from the second signal by directly measuring the differential signal between the first and second receivers.

3. The method of claim 1, wherein the first and second signals are separately measured the first signal is subsequently subtracted from the second signal to obtain the differential signal.

4. The method of claim 1, wherein the first and second receivers are located on the same side of the transmitter.

5. The method of claim 4, wherein the plurality of receivers further comprises a third receiver located on the same side of the transmitter as the first and second receivers and receiving a third response signal, the second and third receivers being configured such that the direct signal contributions in their response signals are substantially equal in the first dimension or in a second dimension different from the first, the method further comprising subtracting the second response signal from the third response signal to obtain a second differential signal in which the signal contributions substantially cancel in the dimension in which they are substantially equal.

6. The method of claim 1, wherein the first and second receivers are located on opposite sides of the transmitter.

7. The method of claim 6, wherein the first and second receivers are coils having substantially equal numbers of windings and sizes, and being located at substantially equal distances from the transmitter, the direct signal contributions in the differential signal further cancelling in a second dimension different from the first dimension.

8. The method of claim 6, wherein the plurality of receivers comprises a third receiver receiving a third response signal, the third receiver being located on the same side of the transmitter as the first receiver and configured such that the direct signal contributions of the first response signal and the third response signal are substantially equal in one of the first and second dimensions, the method further comprising subtracting the first response signal from the third response signal to obtain a second differential signal in which the signal contributions substantially cancel in the one of the first or second dimensions.

9. The method of claim 8, wherein the plurality of receivers further comprises a fourth receiver receiving a fourth response signal, the fourth receiver being located on the same side of the transmitter as the second receiver and at substantially the same distance from the transmitter as the third receiver, the third and fourth receivers being coils having substantially the same numbers of windings, the method further comprising subtracting the third response signal from the fourth response signal to obtain a third differential signal in which the direct signal contributions substantially cancel in the first and second dimensions and subtracting the second response signal from the fourth response signal to obtain a fourth differential signal in which the direct signal contributions substantially cancel in the one of the first or second dimensions.

10. The method of claim 1, wherein the electromagnetic wave is emitted in a frequency range below 20 Hz.

11. A pipe inspection tool comprising:
an electronics board comprising a digital-waveform generator configured to generate a voltage in a frequency range below 20 Hz;
a transmitter configured to emit an electromagnetic wave in response to application of the generated voltage;
a plurality of receivers configured to acquire electromagnetic response signals, the response signals comprising direct signal contributions due to direct transmission of the emitted electromagnetic wave to the respective receivers, the plurality of receivers comprising first and second receivers configured such that direct signal contributions in their response signals substantially cancel, in at least one dimension, in a differential signal formed by subtraction of the first response signal from the second response signal.

12. The pipe inspection tool of claim 11, further comprising a non-magnetic metal sleeve enclosing the transmitter and the plurality of receivers.

13. The pipe inspection tool of claim 11, wherein the first and second receivers are coils having equal numbers of windings and equal sizes and are located on opposite sides of the transmitter at substantially equal distances from the transmitter.

14. The pipe inspection tool of claim 13, wherein the plurality of receivers further comprises a third receiver located on the same side of the transmitter as the first receiver, the second and third receivers being configured such that the direct signal contributions in their response signals cancel, in at least one dimension, in a second differential signal formed by subtraction of the first response signal from the third response signal.

15. A system comprising:
a pipe inspection tool to be disposed in a set of one or more pipes, the tool comprising a transmitter to emit an electromagnetic wave and a plurality of receivers to acquire resulting electromagnetic response signals comprising direct signal contributions due to direct transmission of the emitted electromagnetic wave to the respective receivers, the plurality of receivers comprising first and second receivers configured such that the direct signal contributions in their respective first and second response signals substantially cancel, in at least one dimension, in a differential signal formed by subtraction of the first response signal from the second response signal; and
a signal-processing facility to process the differential signal to derive based thereon at least one pipe parameter associated with the set of one or more pipes, the at least one pipe parameter comprising at least one of a pipe thickness, a pipe diameter, a magnetic permeability, or an electrical conductivity.

16. The system of claim 15, wherein the pipe inspection tool further comprises voltage measurement circuitry connected to the first and second receivers so as to directly measure the differential signal.

17. The system of claim 15, wherein the pipe inspection tool is configured to separately measure the first and second response signals, the signal-processing facility being configured to subtract the first response signal from the second response signal.

18. The system of claim 15, wherein the first and second receivers are located on opposite sides of the transmitter at substantially equal distances from the transmitter and comprise receiver coils having substantially equal numbers of windings and equal sizes.

19. The system of claim 18, wherein the plurality of receivers further comprises a third receiver located on the same side of the transmitter as the first receiver, the first and third receivers being configured such that the direct signal contributions in their response signals cancel, in at least one dimension, in a second differential signal formed by subtraction of the first response signal from a third response signal received with the third receiver.

20. The system of claim 19, wherein the signal-processing facility is to derive the at least one pipe parameter associated with the set of one or more pipes based further on the second differential signal.
